(19) United States
(12) Patent Application Publication
(10) Pub. No.: US 2012/0004923 A2
(43) Pub. Date: Jan. 5, 2012

(54) ELECRONIC IMAGE DISPLAY FLAG

(76) Inventors: Crystal GAINES, Philadelphia, PA (US); Angelique DEAS, Charlotte, NC (US)

(21) Appl. No.: 12/875,832

(22) Filed: Sep. 3, 2010

(51) Int. Cl. G09G 5/00; H04R 19/04; G06Q 30/00; G09G 5/36

(52) U.S. Cl. 705/1.1; 345/204; 345/556; 381/361

(57) ABSTRACT

The disclosed electronic image display flag for a microphone includes an electronic image display screen for displaying images and electronics for driving the electronic image display screen, wherein the electronic image display screen is viewable substantially 360° around the axis of an aperture into which a microphone slips, and wherein said electronics for driving the electronic image display screen includes an image orientation circuit orienting the image displayed on the electronic image display screen to be consistently oriented in a particular direction relative to a given reference.

### FIELD

The present invention relates to flags for microphones, and more particularly to flags with at least one electronic image display screen capable of dynamically displaying logos and the like.

### BACKGROUND

Common microphone flags 110, such as illustrated in FIG. 1, are the cubic or triangular solids that can be attached to the handle part of hand-held microphones 120. The common flag 110 has indicia 130 such as logos of production companies, broadcast or cable networks/stations, or logos of other types of companies on each of the flat surfaces 112. A fundamental problem with common microphone flags 110 is that relative camera orientation typically changes as the common flag 110 is used. For instance, during an interview with an athlete, a sports reporter will usually hold the microphone towards the athlete then to herself as each person talks during the interview. Unless the interviewer concentrates on the orientation of the flag 110 relative to a camera, at times the indicia (logo) 130 on the flag 110 will at times be at an odd angle from the perspective of the camera, such that the logo 130 is not understandable from the perspective of an audience member looking at the image taken by the camera.

Further, the indicia 130 on microphone flags 110 are static. To change the logo or other indicia 130, one has to change the flag 110 or at least the surface bearing the indicia.

### SUMMARY OF THE DISCLOSED ELECTRONIC IMAGE DISPLAY FLAG

The present inventors have realized that microphone flags present a great opportunity to advertise since they are nearly always in the picture when a person is being interviewed or a person performing in front of a camera. The flag can stay in frame for the duration of a segment of a show or even the entire show. Yet, the traditional flag is often a simple logo of a company or media outlet that cannot always be seen well by audience members. This is due to the logo image being rotated at an odd angle relative to the camera such that it becomes difficult to read, for instance. Perhaps due in part to this common problem, the full advantage of the advertising opportunity presented by microphone flags has not been realized.

Hence, exemplary embodiments of the present electronic image display flag displays a dynamic image that better maintains an orientation to the camera. Additionally, the image can be dynamic as to content, e.g., by temporarily changing the image such that different images appear over time, either on a timed basis or based on factors external to the device, such as the content of the interview. Further still, the content can be different on one or more screens of the electronic image display flag.

The present inventors have invented electronic image display flags that, depending on the embodiment, more fully exploit the advertising potential of microphone flags.

### BRIEF DESCRIPTION OF THE DRAWINGS

The present electronic image display flag will now be described by way of exemplary embodiments to which it is not limited. Variations and modifications will occur to those skilled in the art without departing from the scope of the invention as claimed at the end of this document, which define the metes and bounds of the invention. In the present description, like reference numbers will describe like or similar parts with the first digit incremented to reflect the figure number.

FIG. 1 illustrates an example of a common microphone flag.

FIG. 2 illustrates one exemplary embodiment of a spherical microphone flag in accordance with the present disclosure.

FIG. 3 illustrates one exemplary embodiment of a triangular microphone flag in accordance with the present disclosure.

FIG. 4 illustrates one exemplary embodiment of a cylindrical microphone flag in accordance with the present disclosure.

FIG. 5 is a high level diagram of one exemplary embodiment of circuitry for microphone flags in accordance with the present disclosure.

FIG. 6 is a high level flowchart illustrating an exemplary method in accordance with the present disclosure.

FIG. 7 is a high level flowchart illustrating the manner in which images are input and controlled on the electronic image display flag.

FIG. 8 illustrates a case for storing, recharging the batteries of and interfacing with one or more electronic display flags.

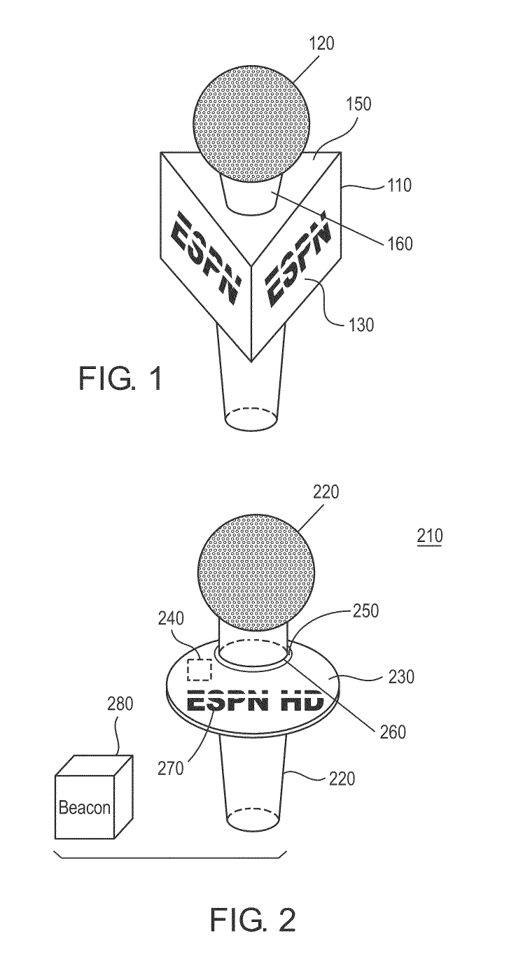

### DETAILED DESCRIPTION OF EXEMPLARY EMBODIMENTS

Overview

An electronic image display flag 210, 310, 410 for a hand-held microphone 220, 320, 420 are illustrated by the exemplary embodiments shown in FIGS. 2, 3 and 4. The electronic image display flag 210, 310, 410 includes an electronic image display screen or screens 230, 330, 430 for displaying images 270, 370, 470. It includes image drive electronics 240, 340, 440 for driving the electronic image display screen 230, 330, 430. A flag housing 250, 350, and 450 supports the electronic image display screen 230, 330, 430 on an exterior portion of the housing, and enclosing the electronics 240, 340, 440 for driving the electronic image display screen 230, 330, 430.

The flag housing has an aperture 260, 360, 460 the axis of which is parallel to a center line of the flag housing. This aperture is dimensioned to receive a handle portion of a microphone 220, 320, 420, and can be bordered with a resilient material (e.g., foam, rubber, or any other suitable material that will frictionally or mechanically secure the flag to the microphone for normal use, but permitting disassociation) friction or mechanically fixing the digital electronic display flag 210, 310, 410 to the microphone handle. The flag and the microphone can be physically attached to each other in any suitable manner, but they can be integral to each other as well. As more fully explained below, the electronic display screen 230, 330, 430 is viewable substantially 360° around the axis. Here it should be noted that as used herein, the phrase “viewable substantially 360° around the axis” of the flag is meant to encompass embodiments that have breaks or gaps in the image that can be visible but do not interfere with the image to a point that the image is not understandable to an observer viewing an image of the digital electronic display flag as taken by a camera. The image is also viewable up and down at an extended angular range, including but not limited to 170°, or whatever the current display device technology permits.

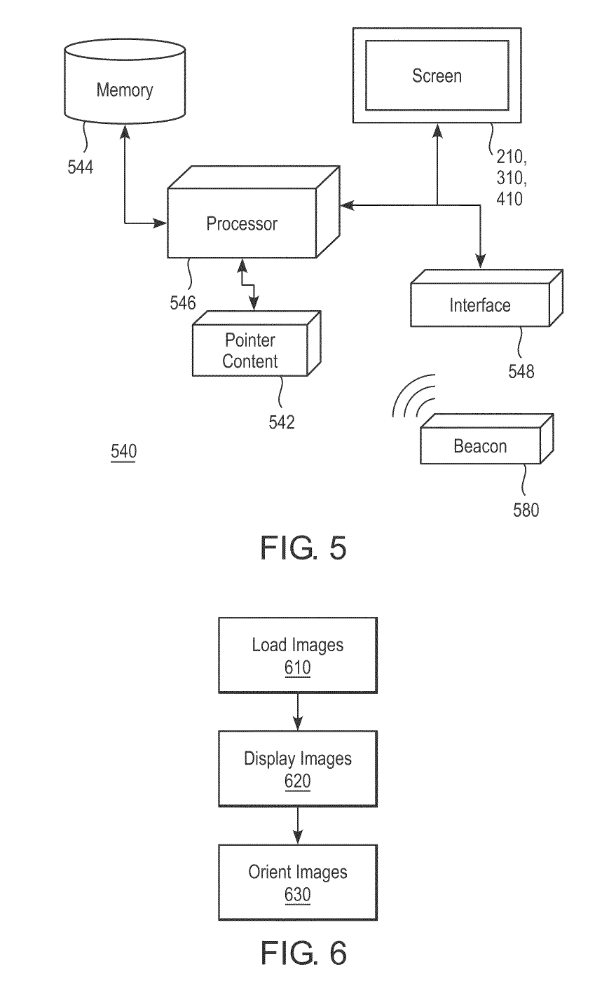

Electronics 540 for driving the electronics display screen includes an image orientation circuit 542 (shown in FIG. 5) orienting the image displayed on the electronic display screen 230, 330, 430 to be substantially consistently oriented (e.g., allowing for delay in sensor and intermediate electronics, may be factors) in a particular direction (e.g., relative to ground or matching the orientation of a camera) relative to a given reference (e.g., pointing toward a beacon 280 attachable or part of a camera), as explained in greater detail below. This can apply to all embodiments of the present electronic image display flag 210, 310, 410.

Flag Shapes

In the exemplary embodiment of FIG. 2, the digital electronic display flag 210 is spherical in FIG. 2, but the same general curved surface or rounded shape can include a toroidal (donut) shape, an ellipsoidal shape, or other shape having a curved surface. More specifically, it is the shape of the electronic display screen 230 that has a geometric shape selected from the group consisting of a sphere, a toroid, and an ellipsoid, or nearly any other shape having a surface curved in two directions. This can be very advantageous in that the flag can be in nearly any orientation relative to a camera and the image displayed thereon still be properly oriented towards a camera, with only the microphone head and the handle creating obstructions to the image to be displayed. In these embodiments, it would not be important, or at least not as important that the axis of an aperture 260 through which a hand-held microphone is inserted be roughly in a plane parallel to the camera.

In the spherical-shaped embodiments can be bifurcated, with a latch on one side and a hinge on the opposite or other point on the side of the sphere. In this way, half or a portion of the sphere can be swung open to expose an interface, portal, and/or dedicated control buttons (explained in more detail below), for instance. Nearly any other suitable access mechanism may be adopted.

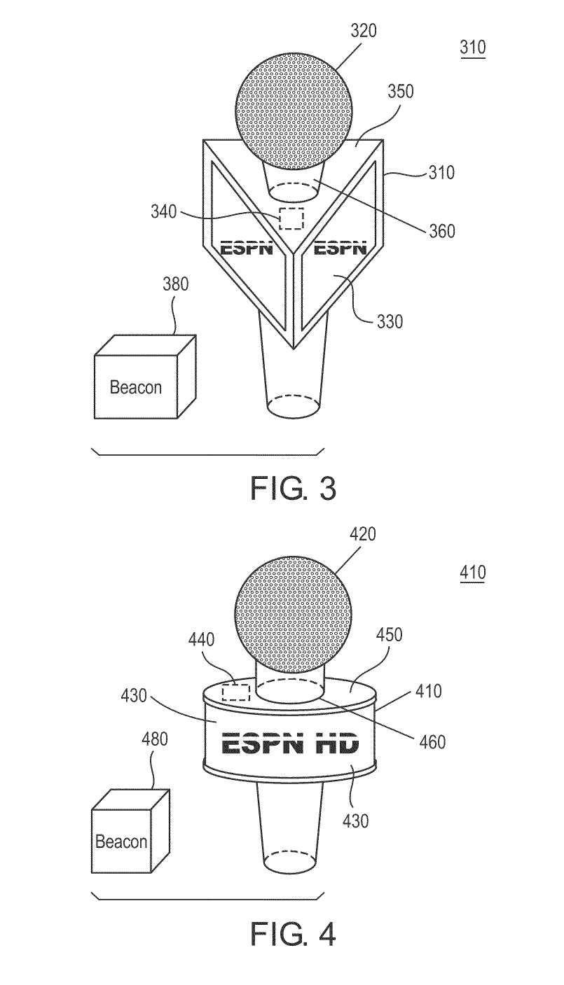

In FIGS. 3 and 4, the electronic image display flag (310, 410) has a surface that is straight in at least one direction. For instance, in FIG. 4, the screen 430 is in the form of a cylinder having a top side and a bottom side with the aperture 460 passing from the top to the bottom side. In FIG. 3, the screen 330 forms the shape of a triangular solid having three sides and a cross-section which forms a triangle, and two parallel sides on top and bottom with the aperture 360 passing from the top to the bottom side. A modification of the embodiment of FIG. 3 can be a four-sided display in the shape of a rectilinear box wherein the display screen is on four sides 90° relative to each other, and two parallel sides on top and bottom with the aperture 360 passing from the top to the bottom side. It can be a two-sided display, with the dynamic image, but such an embodiment would require the user to make sure the image sides, rather than the ends, face the camera.

As can be seen, the shape of the electronic image display screen generally defines the shape of the flag in these exemplary embodiments. However, modifications are envisioned wherein the flag includes exposed portions that are not part of the display screen (e.g., top or bottom collars, flanges or ribs between portions of the display screen 230, 330, 430) that include permanent indicia, such as the logo or name of a broadcast network.

Electronic Image Display Screen Drive Electronics

The electronics for driving the electronic image display screen 210, 310, 410 in one embodiment can include an acceleration sensor (e.g., a known micro-electro-mechanical or MEMs device) for determining the direction of gravity. The acceleration sensor outputs an electrical signal that when amplified and digitized can be used to control the image displayed on the electronic image display screen 230, 330, 430 can be oriented relative to the gravitational force at all times regardless of the orientation of the electronic image display flag 210, 310, 410. In a simple embodiment, the gravitational sensor is the only control on the orientation of the image being displayed to assure that the image is nearly always perpendicular to the ground. In this way, as a person interviewing someone moves the microphone back and forth between herself and the person being interviewed, for example, the image will remain oriented such that it can be viewed without the observer or camera having the need to mentally or physically tilt their head (or the camera) to maintain the image in its intended orientation for easiest viewing.

The electronic image drive electronics 540 can also include a pointer circuit 542 that, using known orientation sensor techniques and circuits, can detect the direction of a beacon 580, which advantageously can be positioned on a camera that is associated with the electronic image display microphone flag. In this regard, a camera is associated with a particular microphone in that a beacon 580, which has already been coupled to the particular flag, is attached to the camera. The beacon 580 and the particular flag are coupled by one recognizing the other from other by the designer's choice of frequency, type of radiation or emanations, encoding or nearly any other known technique for one wireless device to recognize and commutate with another.

In this embodiment, not only would the orientation of the image be maintained relative to the ground, it would rotate around the electronic display screen to remain pointing toward the camera. In other words, the electronics 540 driving the electronic display screen includes a sensor or pointer circuit 542 responsive to the orientation of an orientation sensor device or beacon 580, the orientation sensor device 580 being placeable on a separate camera such that the image displayed on the electronic image display screen can be oriented relative to the camera at all times regardless of the orientation of the electronic display flag. The orientation sensor 580 can include one or more of a radio frequency (RF) generator, an infrared (IR) generator, and a magnetic field generator or other suitable mechanisms for determining relative orientations.

Most elaborately, the pointer circuit 542 and the orientation circuit 580 can detect the position and relative orientation of the other as is done with the Nintendo® Wii® remote controllers through a combination of acceleration sensors and IR sensors which through triangulation techniques can determine the relative position and orientation of each other. In this way, if the camera tilts or pans, or both, such as to catch the attention of the viewer, the image on the display screen would maintain its orientation to the camera, and hence to the viewer of the images generated by the camera.

Of course it will be understood that the pointer circuit 542 and the orientation sensor 580 can be reversed, with the pointer circuit 542 being placed on the camera and orientation sensor 580 being placed on the flag. A communications link would then feed-back orientation information from the camera location to the electronic image display drive electronics 540.

The electronic image display drive electronics 540 for driving the electronic image display screen would in most instances include a memory 544 for storing images and a processor 546 for displaying at least one image. It would also include a battery, or power cord if a wired microphone. If battery operated, then preferably the battery would be an extended life battery and preferably be modular so that it could be replaced quickly.

The processor 546 in some exemplary embodiments would be programmed to process a two-dimensional electronic image of the image to be a three-dimensional, undistorted image when viewed at a given orientation when displayed, which is particularly advantageous when using curved surface display screens. The software, firmware and/or hardware (or combinations thereof) implemented program would, for instance, manipulate a flat logo to form a curve logo that when viewed on the electronic image display flag would look undistorted. The program would also control the sequence of the images changing according to a schedule or to content of an interview, perhaps with the intervention of an operator either on camera or off-camera, the images which would be uploaded. The program could also receive, though a wired or wireless connection, from a control program operated from a control booth that controls the overall show or event programming. In this way the imaging on the electronic image display flag can be controlled by the people controlling the overall entertainment program recording. In this way the advertisements can be dynamically controlled with the content or coordinated with unscheduled events during the program.

Additionally or alternatively, the processor 546 can sequentially change the image on the digital flag according to a preloaded schedule or by operation of a user.

The electronic image display screen 230, 330, 430 can include an interface 548 (e.g., touch screen, keypad that might be selectively attachable or wireless keypad including using close range wireless (e.g., Bluetooth®) links with a Smartphone) for controlling the electronic display screen by an operator. Additionally or alternatively, the electronics 540 for driving the electronic display screen can include an input/output portal for loading the images and programming the sequence and timing of the image display. This portal can be one or more of a wireless connection using a short range wireless protocol selected from IEEE 802.11, Wi-Fi, Bluetooth®, ultra wide band, or a wired connection using a USB port, an Ethernet port, a 8P8 jack, an optical jack, S-video jack, RGB connectors, D-subminiature connectors, and an HDMI jack, to name but a few examples. In this regard, in certain embodiments the interface (e.g., one or more of a keypad, dedicated buttons, control function screen, ports (e.g., female connectors) and/or indicator lights) could be on a flat surface of the flag housing, for example. In the exemplary embodiment of FIG. 2, this might be a flat surface that is exposed when a portion of the spherical housing 250 is swung open as the hinge, mentioned above. In the exemplary embodiment of FIGS. 3 and 4, the interface could be on the bottom surfaces of the flag housing 350, 450.

In certain embodiments, perhaps as a default function, the electronic image display driving circuit will have a setting in case there is a malfunction or it is not appropriate to dynamically display indicia (e.g., ad logos). The default setting can be activated automatically such as when it is detected that nothing is in memory, the program or schedule for changing images is not working or the electronics detects a fault condition, and/or can be a switch or button on the interface a user can turn on. In this case, a default image will be continuously displayed (e.g., a network digital logo).

It is also mentioned in passing that the electronics 540 for driving the electronic display screen includes electronics for carrying out all the normal display features and techniques, such as image transitions (dissolving, swiping, and fading in or out).

Digital Electronics Display Screen

The images to be displayed on the electronic display screen 230, 330, 430 can be various kinds of indicia and the present invention is not limited to any particular indicia. The images can be text or picture (e.g., logos) or both, and can be in the form of digital pictures or graphics, and can be generated text that when displayed forms an image. The present invention is also not limited to a particular image file format or manner of generating an image on an electronic display screen.

The electronic display screen 230, 330, 430 can be nearly any form of electronic display including a rear projection screen, an organic light emitting diode (OLED) screen, a light emitting diode (LED) screen, a digital light processor, liquid crystal on silicon (LCoS), electroluminescent displays, or a plasma display to name a few. In the embodiments that have flat segments, such as in FIG. 3, the display screen would comprise three (or four or more) display screens that are driven together to form one continuous display or independent displays. In the spherical or curved displays of FIGS. 2 and 4, a flexible display substrate might be advantageously used. It may also be advantageous to use a rear projection system wherein images are projected by a micro image projector or digital light processor with it mirrors to project light onto translucent display screens, which might provide more dynamic images and avoid the need for producing curves displays.

Integrated Solutions

From the above embodiments, it can be seen that the flag can be separate from the microphone, which can be advantageous in that the two devices would not normally have interrelated functions, but it is envisioned that they can be combined as a hand-held microphone that includes both a microphone that can be held in a human hand and an electronic flag in accordance with one of the above embodiments. While having the electronic image display flag and the microphone separated can have the advantage of being able to swap one out for another, an integrated approach might be advantageous, for example, if some of the electronics or a power supply (not shown in the figures) can be shared.

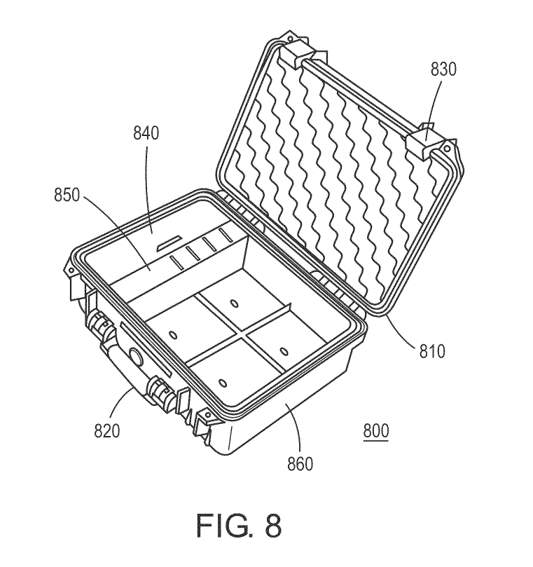

FIG. 8 illustrates a suitable storage case 800, complete with outer shell 810, handle 820 and a latching or locking mechanism 830. In addition, there is a storage compartment 840 holding a battery (not shown) and/or various cords used to recharge electronic image display flags (now shown) either by direct connection or through an interface connection (e.g., USB) within the storage compartments 860 for each electronic image display flag. Various indicators and controls can be part of a control panel 850. In this way, the storage case in the exemplary embodiment of FIG. 8 can facilitate the transfer of information either stored therein or through connection (wired or wireless) to another computing device, allow for battery recharging and provide for safe storage and transportation.

Method of Use

Though implicit from the above, the present disclosure can involve a method of advertising on a microphone flag, such as illustrated in the exemplary embodiment of FIG. 6. In essence, the method would involve step 610 of loading at least one image into a memory of a digital flag and step 620 selectively displaying the stored image or images on a display screen of the digital flag. By operation of the electronics, the image displayed on the display screen of the digital flag would be caused to display the image or images at a particular orientation of the digital flag to a camera regardless of the orientation of the microphone flag to the camera within normal operating parameters, as shown in step 630.

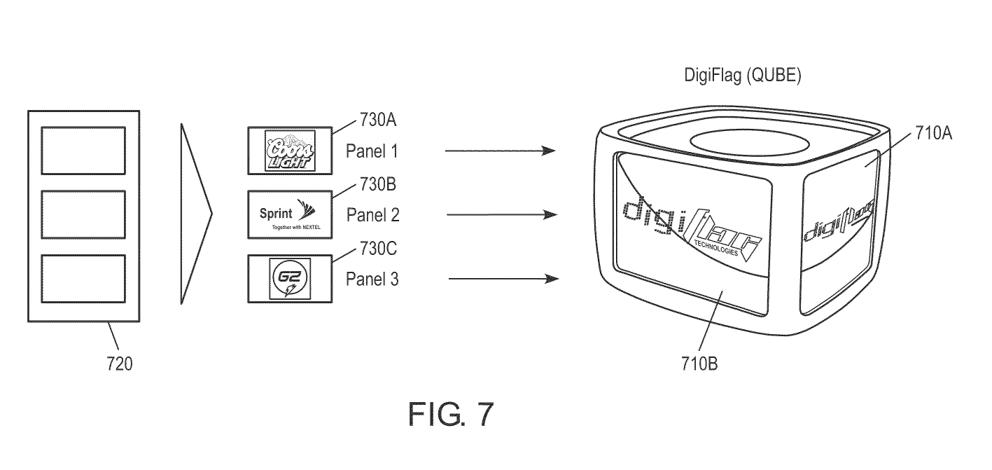

As a further detail, FIG. 7 illustrates that the images can be downloaded from an advertiser to the media outlet using the electronic display flag through a website 720, for instance. Each panel 710A, 710B in a multipanel embodiment can be separately controlled to carry different images 730A, 730B, 730C or controlled to carry the same image, by downloading the images through the internet of other connection to the flags 210, 310, 410 via a wired or wireless connection (using or bypassing the case 800, as described above. Further, the timing and sequence can be controlled and recorded so that the advertiser can maximize impact of the advertiser and the media outlet or an intermediary company can charge for the ad time, views or other matrix information, is recorded for recovery or auditing.

Having described the invention by way of exemplary embodiments to which it is not limited, the metes and bounds of the invention will now be defined by the claims appended hereto.

What is claimed is:

1. An electronic image display flag for a microphone, comprising:
an electronic image display screen for displaying images;
electronics for driving said electronic image display screen; and
a flag housing for supporting the electronic image display screen on an exterior portion of the housing, and enclosing the electronics for driving the electronic image display screen, said housing having an aperture in an axial direction thereof dimensioned to receive a handle portion of a microphone,
wherein the electronic display screen is viewable substantially 360° around said axis, and
wherein said electronics for driving the electronic image display screen includes an image orientation circuit orienting the image displayed on the electronic image display screen to be consistently oriented in a particular direction relative to a given reference.

2. The electronic display flag of claim 1, wherein the electronic image display screen has a geometric shape selected from the group consisting of: a sphere; a toroid, an ellipsoid, a cylinder having a top side and a bottom side with the aperture passing from the top to the bottom side; a triangular solid having three sides and a cross-section which forms a triangle, and two parallel sides on top and bottom with the aperture passing from the top to the bottom side; a rectangular box wherein the display screen is on four sides 90° relative to each other, and two parallel sides on top and bottom with the aperture passing from the top to the bottom side.

3. The electronic display flag of claim 1, wherein said electronics for driving the electronic image display screen includes an acceleration sensor for determining the direction of gravity such that the image displayed on the electronic image display screen can be oriented relative to one of (a) gravitational force at all times regardless of the orientation of the electronic image display flag and (b) a beacon positioned on a camera that is associated with the microphone flag.

4. The electronic display flag of claim 1, wherein the electronics driving the electronic image display screen includes a sensor responsive to the orientation of an orientation sensor device, said orientation sensor device being placeable on a separate camera such that the image displayed on the electronic display screen can be oriented relative to the camera at all times regardless of the orientation of the electronic image display flag, and wherein said orientation sensor device includes one of a radio frequency (RF) generator, an infra red (IR) generator, and a magnetic field generator.

5. The electronic display flag of claim 1, wherein the electronic image display screen is selected from a group consisting of rear projection screen, an organic light emitting diode (OLED) screen, a Light emitting diode (LED) screen, a digital light processor, liquid crystal on silicon (LCoS), electroluminescent displays, and a plasma display.

6. The electronic display flag of claim 1, wherein the electronics for driving the electronic image display screen include a memory for storing images and a processor for displaying at least one image.

7. An electronic display flag of claim 5, wherein the processor processes a two-dimensional electronic image of the image to be a three-dimensional, undistorted image when viewed at a given orientation when displayed.

8. The electronic display flag according to claim 1, wherein the electronics for driving the electronic image display screen include a processor for sequentially changing the image on the digital flag according to a preloaded schedule.

9. The electronic display flag according to claim 1, wherein the electronic display screen includes an interface for controlling the electronic image display screen by an operator.

10. The electronic display flag according to claim 1, wherein the electronics for driving the electronic image display screen includes an input/output portal.

11. The electronic display flag according to claim 10, wherein the portal is one of wireless connection using a short range wireless protocol selected from IEEE 802.11, Wi-Fi, Bluetooth, ultra wide band, or a wired connection using a USB port, an Ethernet port, a 8P8 jack, an optical jack, S-video jack, RGB connectors, D-subminiature connectors, and an HDMI jack.

12. The electronic display flag according to claim 10, wherein the electronics for driving the electronic image display screen includes electronics for transitions, selected from the group consisting of dissolving, swiping, and fading in or out.

13. A hand-held microphone comprising:
a microphone that can be held in a human hand; and
an electronic image display flag in accordance with claim 1.

14. A method of advertising on a microphone flag, comprising the steps of:
loading at least one image into a memory of an electronic image display flag;
selectively displaying said at least one image on a electronic image display screen of the electronic image display flag; and
causing the at least image displayed on the display screen of the electronic image display flag to display the at least one image at a particular orientation of the electronic image display flag to a camera regardless of the orientation of the electronic image display flag to the camera within normal operating parameters.

15. An electronic image display flag for a microphone, comprising:
an electronic image display screen for displaying images;
electronics for driving said electronic image display screen; and
a flag housing for supporting the electronic image display screen on an exterior portion of the housing, and enclosing the electronics for driving the electronic image display screen, said housing having an aperture in an axial direction thereof dimensioned to receive a handle portion of a microphone,
wherein the electronic display screen is viewable substantially 360°, around said axis, and wherein said electronics for driving the electronic image display screen dynamically changes the image displayed on the electronic image display screen.

16. An electronic image display flag for a microphone according to claim 15, wherein the shape of the flag is selected from the group of:
sphere, torus, ellipsoid, cylinder, triangular solid, 2 sided vertical, box, 2 sided horizontal.

17. An electronic image display flag for a microphone according to claim 15, wherein said electronics for driving the electronic image display screen includes:
an acceleration sensor to orient the image displayed relative: (a) gravitational force at all times regardless of the orientation of the electronic image display flag and (b) a beacon positioned on a camera that is associated with the microphone flag.

18. An electronic image display flag for a microphone according to claim 15, wherein said electronics driving the electronic image display screen includes:
sensor responsive to the orientation of an orientation sensor device, placeable on a separate camera such that the image may be oriented independently from the orientation of the display flag, wherein the sensor device includes one of a radio frequency (RF) generator, an infra red (IR) generator, and a magnetic field generator.

19. An electronic image display flag for a microphone according to claim 15, wherein the electronic image display screen is selected from a group consisting of:
rear projection screen, an organic light emitting diode (OLED) screen, a light emitting diode (LED) screen, a digital light processor, liquid crystal on silicon (LCoS), electroluminescent displays, and a plasma display.

20. An electronic image display flag for a microphone according to claim 15, wherein the electronics for driving the electronic image display screen include:
a memory for storing images and
a processor for displaying at least one image.

21. An electronic image display flag for a microphone according to claim 19, wherein the processor processes:
a two-dimensional electronic image of the image, to be a three-dimensional, undistorted image when viewed at a given orientation when displayed.

22. An electronic image display flag for a microphone according to claim 15, wherein the electronics for driving the electronic image display screen include a processor for:
sequentially changing the image on the digital flag according to a preloaded schedule.

23. An electronic image display flag for a microphone according to claim 15, wherein the electronic display screen includes:
an interface for controlling the electronic image display screen by an operator.

24. An electronic image display flag for a microphone according to claim 15, wherein the electronics for driving the electronic image display screen includes:
an input/output portal.

25. An electronic image display flag for a microphone according to claim 24, wherein the portal is one of:
wireless connection using a short range wireless protocol selected from IEEE 802.11, Wi-Fi, Bluetooth, ultra wide band, or
a wired connection using a S-video jack, RGB connectors, D-subminiature connectors, and an HDMI jack.

26. An electronic image display flag for a microphone according to claim 24, wherein the electronics for driving the electronic image display screen includes:
electronics for transitions, selected from the group consisting of dissolving, swiping, and fading in or out.

27. A handheld microphone comprising:
a microphone that can be held in a human hand; and
an electronic image display in accordance as in claim 15.

28. A method of advertising on a microphone flag, comprising the steps of:
loading at least one image into a memory of an electronic image display flag;
selectively displaying said at least one image on a electronic image display screen of the electronic image display flag; and
causing the at least image displayed on the display screen of the electronic image display flag to display the at least one image at a particular orientation of the electronic image display flag to a camera regardless of the orientation of the electronic image display flag to the camera within normal operating parameters.

29. A handheld microphone flag comprising:
a support structure for holding one or more image display screens, said support structure having an aperture in an axial direction thereof and dimensioned to receive a handle portion of a microphone;
one or more electronic image display screens attached to the support structure, wherein one or more images are viewable from substantially all angles around the flag, such display screens selected from a group consisting of: a rear projection screen, an organic light emitting diode (OLED) screen, a light emitting diode (LED) screen, a digital light processor, liquid crystal on silicon (LCoS), electroluminescent displays, and a plasma display; and
driving electronics for operating said one or more electronic image display screen, such electronics comprising:
computer memory, a processor, and an input-output portal, wherein the driving electronics function to cause one or more images to be dynamically displayed on said one or more electronic image display screen.
